(19) United States
(12) Patent Application Publication
(10) Pub. No.: US 2019/0260972 A1
(43) Pub. Date: Aug. 22, 2019

(54) RAIL VEHICLE UNDERFRAME INSPECTION DEVICE AND METHOD

(71) Applicant: ALSTOM Transport Technologies, SAINT-OUEN (FR)

(72) Inventor: Norbert BEHETY, HAGUENAU (FR)

(21) Appl. No.: 16/278,717

(22) Filed: Feb. 19, 2019

(30) Foreign Application Priority Data
Feb. 22, 2018 (FR) 18 51511

(51) Int. Cl. H04N 7/18; H04N 5/232; B61L 27/00

(52) U.S. Cl. CPC H04N 7/185; B61L 25/025; B61L 27/0094; H04N 5/23299

(57) ABSTRACT

A method for inspecting the underframe of a railway vehicle by an inspection device that includes a processing block and a motor system, the processing block commanding and controlling the motor system which moves the inspection device until it is positioned at least at one destination point, the method including: given a list of coordinates of points of interest of the underframe expressed in a reference frame having as origin a reference point, moving the inspection device up to a predetermined point whose position relative to the reference point is known, recording the location of the reference point as a function of the position, and determining at least one command to be sent to the motor system in order to position the inspection device at a point of interest from the list based on the coordinates of the point of interest and the location of the reference point.

### CROSS-REFERENCE TO RELATED APPLICATIONS

This application claims priority of French Patent Application No. 18 51511, filed on Feb. 22, 2018.

### FIELD OF THE INVENTION

The present invention relates to the field of maintenance inspections that must be carried out at regular intervals on railway vehicles in order to ensure their integrity and, hence, the safety of persons and goods being transported.

### BACKGROUND OF THE INVENTION

These visual inspections carried out by human operators necessitate the installing of vehicles over dedicated railway inspection tracks (trenched railroad tracks, raised railroad tracks, etc.), which affects the availability of vehicles, entails specific movements thereof and contributes to bottlenecks and over-burdening of the infrastructures and facilities, while also subjecting the human operators to working conditions that are difficult, and unfavorable in terms of health and safety. In addition, as 90% of the component members of the vehicle that are inspected are determined to be compliant upon conclusion of the inspection, a relaxing of the concentration necessary to perform these inspections may be feared.

There is thus a need to provide a vehicle inspection solution for inspecting a railway vehicle which is easy to implement and makes possible the remote operation and driving of an inspection device to the zones of the railway vehicle that are to be inspected.

### SUMMARY OF THE DESCRIPTION

To this end, according to a first aspect, the invention provides a railway vehicle underframe inspection method for inspecting the underframe of a railway vehicle on a railway track by means of an inspection device comprising a processing block and a motor system, the processing block being adapted so as to command and control the motor system and the motor system being adapted so as to move the inspection device until it is positioned at least at one destination point commanded and controlled by the processing block;

the said method being characterized in that, given a list, which is saved and stored in the processing block, of coordinates of points of interest of the underframe expressed in a reference frame having as origin a reference point, the method includes the following steps:
moving of the inspection device up to a predetermined point whose position relative to the reference point is known;
recording and saving, by the processing block, of the location of the reference point as a function of the position up to which the device has been moved;
determining, by the processing block, of at least one command intended to be sent to the motor system in order to position the inspection device at least at one point of interest from the list on the basis of at least the coordinates of the point of interest expressed in the list and of the recorded and saved location of the reference point.

The invention thus makes it possible to provide a solution so as to facilitate rapidness and reliability in the automation of inspection operations. Once the actual position of the reference point of the railway vehicle inspected has been recorded and saved during maintenance, the inspection device then has the ability to effectively determine the optimal movement necessary in order to inspect each component of the railway vehicle. Another advantage, linked to the reference data base for indexing-referencing of the underframe equipment units for each type of train referenced, is to be able to identify the equipment units in the vicinity of the robot, and the inspections catalogued for these equipment units.

The optimization of movements makes it possible to reduce them and therefore to preserve the energy (battery) necessary for the movements, thereby increasing the autonomy of the robot.

In the embodiments, the inspection method according to the invention includes in addition one or more of the following characteristic features:
the processing block supplies the command determined to the motor system, and then, on the basis of the command, the inspection device moves as a result of the action of the motor system up to the point of interest and captures an image thereof or performs a measurement thereat;
the predetermined point is an axle of the mobile railway vehicle, the location of the reference point on an axis X extending parallel to the track being the one corresponding to the axle on the axis X, the location of the reference point on an axis Y, situated in the plane of the track and perpendicular to the rails of the track, being determined as a function of the location of at least one of the two rails on the axis Y, and the location of the reference point on an axis Z, perpendicular to the axes X and Y, being determined as a function of the location of at least one of the two rails on the axis Z;
the following steps are operationally implemented:
   calculation of a surface area corresponding to an envelope of a surface of the underframe of the railway vehicle;
   determination of movement(s) of the inspection device to be brought about between two successive points of interest of the list by means of implementation of a minimization algorithm for minimizing the movements brought about in 1 dimension, 2 dimensions or 3 dimensions, the minimization being carried out on the basis of the points of the list and of the envelope calculated.

According to a second aspect, the present invention provides a computer program including software instructions which, when they are executed by a computer, operationally implement a method as defined hereabove.

According to a third aspect, the present invention provides a railway vehicle underframe inspection device for inspecting the underframe of a railway vehicle on a railway track including a processing block and a motor system, the processing block being adapted so as to command and control the motor system, and the motor system being adapted so as to move the inspection device until it is positioned at least at one destination point commanded and controlled by the processing block;

the device being characterized in that, given a list, which is saved and stored in the processing block, of coordinates of points of interest of the underframe expressed in a frame of reference having as origin a reference point, the processing block is adapted so as to, following a movement of the inspection device up to a predetermined point whose position relative to the reference point is known, record and save a location of the reference point as a function of the position up to which the device has been moved;
the processing block being adapted so as to determine at least one command intended to be sent to the motor system in order to position the inspection device at least at one point of interest from the list on the basis of at least the coordinates of the point of interest expressed in the list and the recorded and saved location of the reference point.

In the embodiments, the inspection device according to the invention comprises in addition, one or more of the following characteristic features:
the processing block is adapted so as to supply the command determined to the motor system, and then, on the basis of the command, the inspection device is adapted so as to move as a result of the action of the motor system up to the point of interest and capture an image thereof or perform a measurement thereat;
the predetermined point is an axle of the railway vehicle, the location of the reference point on an axis X extending parallel to the track being the one corresponding to the axle on the axis X, the location of the reference point on an axis Y, situated in the plane of the track and perpendicular to the rails of the track, being determined as a function of the location of at least one of the two rails on the axis Y, and the location of the reference point on an axis Z, perpendicular to the axes X and Y, being determined as a function of the location of at least one of the two rails on the axis Z;
the processing block is adapted so as to determine the movement(s) of the inspection device to be brought about between two successive points of interest of the list by means of implementation of a minimization algorithm for minimizing the movements brought about in 1 dimension, 2 dimensions or 3 dimensions, the minimization being carried out on the basis of the points of the list and of an envelope of a surface of the underframe of the railway vehicle.

### BRIEF DESCRIPTION OF THE DRAWINGS

These characteristic features and advantages of the invention will become apparent upon reading the description which follows, given solely by way of example, and with reference made to the appended drawings, in which:

FIG. 1 represents a schematic view of an inspection device in one embodiment of the invention;

FIG. 2 is a view of the railway track and of the reference axes in one embodiment of the invention;

FIG. 3 is a block diagram of an inspection device in one embodiment of the invention;

FIG. 4 is a flowchart of steps operationally implemented in one embodiment of the invention;

FIG. 5 is a flowchart of steps operationally implemented in one embodiment of the invention; and

FIG. 6 represents the movements brought about in the embodiments of the invention.

### DETAILED DESCRIPTION

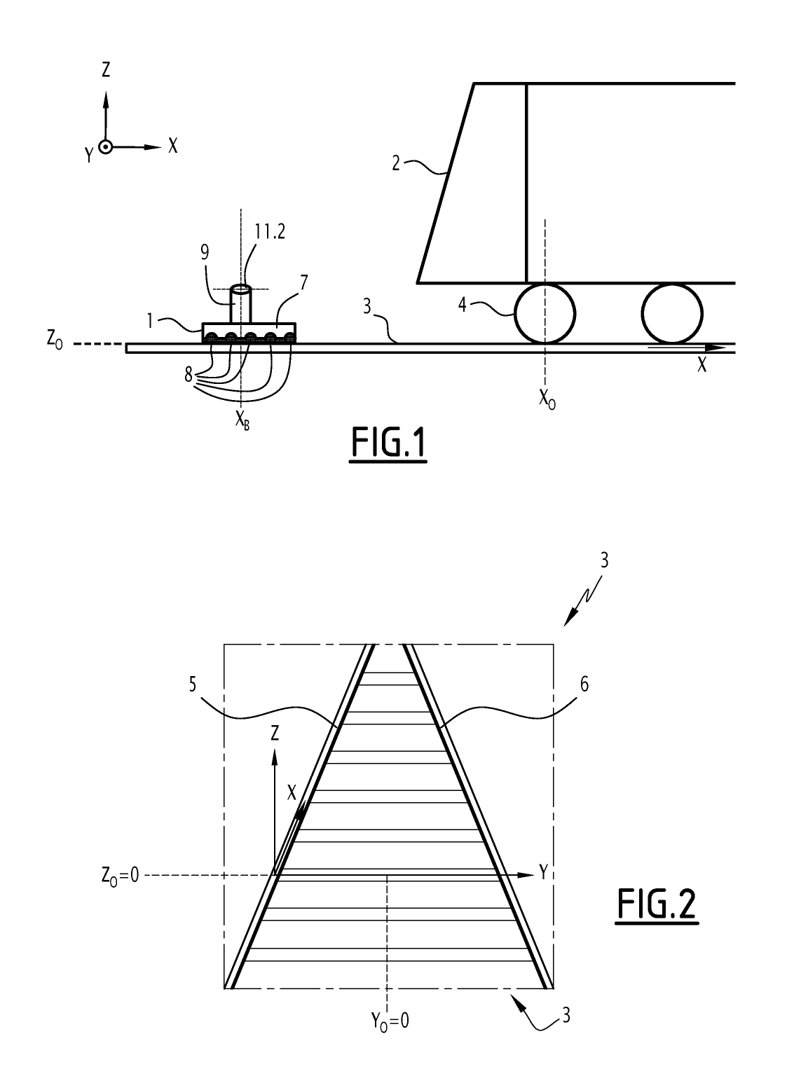

FIG. 1 schematically represents an inspection device 1, also referred to as robot 1, in one embodiment of the invention. The inspection device 1 is adapted so as to inspect the chassis of a railway vehicle 2, in the case considered a train 2 (in other cases a tram, a locomotive, etc.), parked on a railway track 3 which extends along an axis X. As represented in FIG. 2, the rails 5 and 6 of the track 3 are found to be in the plane defined by the orthogonal axes X and Y, themselves perpendicular to a vertical axis Z.

The inspection device 1 includes a carriage 7 provided with wheels 8 and an arm 9. When the inspection device 1 is placed between the rails, for example with the wheels over the feet of the rails 5 and 6, it is adapted so as to travel on these rails and thus to move along the axis X, driven by a motor system mentioned later. The arm 9 is adapted so as to expand (deploy) or retract along the axis Z and also along the axis Y, as a result of the action of the motor system. At the top of the arm 9, an application device 11.2 is arranged. In the case considered, the application device is a video camera 11.2 (in other embodiments, the application device includes a measurement apparatus). The dimensions of the inspection device 1 are appropriate in order for it to travel, between the rails 5 and 6, under the chassis of the train 2, by means of folding of the arm along the axis Z, or even along the axis Y, depending on the volumes of the train on the route of the inspection device 1.

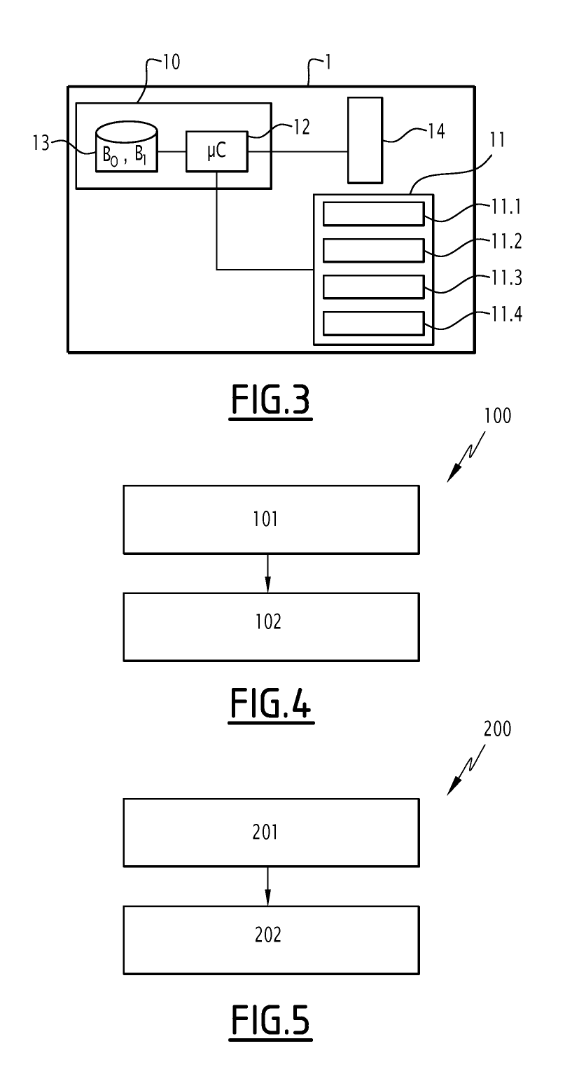

FIG. 3 is a block diagram of the inspection device 1 in the embodiment of the invention considered. The inspection device 1 includes a processing block 10, an assembly of systems 11 and a wireless telecommunication interface 13.

The processing block 10 includes a microprocessor 12 and a memory storage zone 14. The assembly of systems 11 includes, in particular, a motor system 11.1, at least one application device 11.2, in this instance a video camera 11.2, a battery 11.3, and a geolocation system 11.4.

The motor system 11.1 is adapted so as to bring about the movements of the inspection device 1, both those of the carriage 7 along the axis X, as well as those of the arm 9 along the axes Y and Z, and that of inclination of the camera head 11.2 in relation to each of the axes X, Y, Z.

The video camera 11.2 is adapted so as to capture images.

The battery 11.3, for example, electric, is adapted so as to supply electrical energy to the entire assembly of the inspection device 1.

The geolocation system 11.4 includes, for example, an inertial unit with 3 gyrometers and 3 accelerometers. The geolocation system is adapted so as to calculate the current position of the carriage 7, and the arm 9, as also the orientation of the camera 11.2.

The wireless telecommunication interface 13 is, for example, of the Wi-Fi type and is capable of exchanging data with a remote monitoring-management station operated by an operator.

The processing block 10 is adapted so as to control and drive the systems of the assembly of systems 11. Thus the processing block 10 is capable of sending commands to the various systems of the systems assembly 11, for example:
sending of the movement commands for movements to be carried out by the carriage 7, the arm 9 and the camera 11.2 in order to position them at a determined location;
sending of the image capture commands to the video camera 11.2.

These commands, originating from the remote monitoring-management station, are, for example, initially received by the processing block 10 via the telecommunication interface 13, before possibly being eventually supplemented, processed and then sent by the processing block 10 to the systems assembly 11: the inspection device is thus then in the manual mode. Or indeed, these commands are part of preprogrammed inspection sequences recorded and saved in the memory storage zone 14 in the form of software instructions, subsequently executed on the microprocessor 12: the inspection device is thus then in the automatic mode.

The processing block 10 is also adapted so as to receive and process the different data transmitted by the various different systems of the systems assembly 11 (for example, the files of images captured by the camera 11.2, the current positions calculated by the geolocation system 11.4, etc.), in order to store them or indeed, as may be appropriate, to transmit them, directly or after processing, to the monitoring-management station via the interface 13.

In the memory storage 14, a database B₀ is stored. This database B₀ includes a list of the components of the train 2 that are to be inspected, and in addition includes, for each component, at least the location coordinates of the component in a frame of reference which has as origin a reference point P₀ of the train 2, as well as the roll, pitch, and yaw angles of the camera head 11.2. These coordinates are, for example, expressed in a frame of reference having as axes the 3 axes X, Y, Z (corresponding to the axes indicated hereabove which are respectively also the longitudinal, lateral, and vertical axes of the train 2).

The coordinates in the database B₀ relating to each component are according to the embodiments those of the component or those of the captured view point of the component.

With reference to FIG. 3, the processing block 10, in a determination mode for determining the reference point, is in addition adapted so as to operationally implement the entire set 100 of subsequent steps.

In one embodiment, steps 101, 102 are operationally implemented following the execution on the microprocessor 12, of software instructions stored in the memory storage zone 14.

In step 101: moving of the inspection device 1 until the latter is found to be located at the position of the reference point P₀.

In step 102, the processing block 10 then identifies the current position (X₀, Y₀, Z₀) of the inspection device as that corresponding to the point P₀ used as the origin in the database B₀ and records and saves it as such. And in addition, for example, it assigns to this position P₀ the coordinates (X₀=0, Y₀=0, Z₀=0), which is the origin of the three-dimensional reference frame comprised of the axes X, Y and Z.

In the embodiment considered, the point P₀ corresponds to the point of coordinates (X₀, Y₀, Z₀), where:
X₀ on the axis X corresponds to the point of contact between the wheel of the front axle and the rail, as represented in FIG. 1;
Y₀ is on the central line situated between the two rails 5 and 6, that is mid-way between two wheels of the train 2 positioned facing each other on the axis Y, as represented in FIG. 2 (for example, determined in an intrinsic manner on account of a symmetrical construction of the inspection device 1 along the axis Y); and
Z₀ corresponds to the upper limit of the rail, as represented in FIG. 2.

In the railway context, CAD systems commonly use this frame of reference. Thus they are able to generate the dimensional particulars for underframe equipment units, that are directly exploitable by the robot. Otherwise, the robot can constitute this frame of reference by means of a scanner mode and specific sensors. In another embodiment, another frame of reference may be used. The determination of the reference point can be performed in manual or automatic mode (“reference point determination” mode):
in manual manner.
   the operator of the monitoring-management station provides the movement commands to the inspection device 1 via the interface 13 in order to bring the inspection device 1 to the reference point, and on the basis of these movement commands, the processing block 10 commands the motor system 11.1 to effect a move until such time as the inspection device 1 is found to be located at the position of the reference point P₀, or indeed
   the operator transports the device to the reference point;
in automatic manner (by pressing of a button on the device 1 or outputting, from the monitoring-management station, the order corresponding to the transition to the automatic determination mode for automatically determining the reference point), the inspection device moves along the rails, controlled and driven by the processing block 10, until it automatically recognizes, for example, the lowest part of the first wheel on its left side (for example by automatic pattern recognition processing on the basis of images provided by the camera 11.2). And, for example, if for any reason the inspection device 1 fails to identify this wheel, the search will be stopped after having advanced 10 meters (m) from a base position (corresponding to the coordinate X_{B} on the axis X, represented in FIG. 1).

After the execution of the reference point determination steps for determining the reference point, the inspection device 1 returns to its base position XB.

In the embodiment described, in step 101, the inspection device is moved up to the reference point. In other embodiments, the inspection device is moved in step 101 up to a characteristic point (for example, that is easily detectable by automatic image-based search), and then determines the geographical position of the reference point on the basis of the geographical position of this characteristic point and information items stored in its memory indicating the delta between these two geographical positions.

Then, once this process of locating the reference point has been carried out, the inspection device 1 is appropriately able, in an “inspection mode”, to:
bring about the movements necessary in order to be positioned successively in each of at least some, or even the totality, of the components of the train 2 figuring in the database B₀ on the basis of the coordinates of the component figuring in the database B₀, and the roll, pitch, and yaw angles of the camera in relation to the axes, X, Y, Z and the position of the reference point P₀ as recorded and saved in step 102 (the movements are stopped in order to set up the measurement when the movements required are judged to have been achieved by means of comparing the movement commands, defined on the basis of the coordinates of the components and of the reference position recorded and saved, to the current positions determined by the geolocation system 11.4); and
in each of these different locations, capture images by using the camera 11.2 (or at these different locations, perform the relevant measurements by making use of measurement devices) and perform appropriate image processing on these images in order to provide an inspection status of the component, for example, from among OK, NOK, indeterminate, or even determine a characterization of a defect or deficiency detected on the component by processing of these images (the characterization includes for example the identification of a type of defect or deficiency from among crack, wear, hole, etc.).

All the points of interest of the train 2 to be inspected would have been referenced, in a prior phase, relative to the reference point P₀, then they are subsequently inspected, the movements commanded and controlled by the processing block 10 then being determined in relation to the reference point P₀.

Thus, in an earlier phase prior to the first execution of the entirety of step 100, in order to constitute the database B₀, the operator successively moves the carriage 7 along X up to each component of the list considered, further also positions the arm 9 along Y and Z, and orients the camera 11.2 in accordance with the view point desired for the inspection of the component of interest of the train 2 (thus then making use of a gauge train that is similar to the train 2). Subsequently the coordinates (x, y, z) and orientations relative to the component are then recorded and saved in the database B₀:
x: longitudinal distance along the axis X between the current position and P₀;
y: lateral distance along the axis Y between the current position and P₀;
z: vertical distance along the axis Z between the current position and P₀;
roll, pitch, yaw angles of the camera head 11.2.

Subsequently, the inspection device 1 could be used to inspect automatically, in inspection mode, the components of the train 2 or of any train having the components at the same location as the train 2 relative to the reference position retained.

In the “inspection mode”, whether it be manual or automatic, the inspection by the inspection device includes a list of tasks to be performed at different locational positions on the chassis of the train. Depending on how these tasks are sequenced, the total duration of the inspection and the consumption of energy can vary in a significant manner.

Thus, in one embodiment of the invention, with reference to FIG. 5, a set of steps 200 is operationally implemented.

In step 201, the tasks in the sequence of tasks to be performed by the inspection device 1 are ordered in a minimizing order in the plane X, Y (given that the movements along Z are taken into account in step 202) the number and the distance of transition between two successive tasks, (for example, taking of pictures of components) corresponding to two successive locational positions (x, y, z) of the inspection device (the optimization algorithms operationally implemented are, for example, similar to those used in the calculations of route itineraries). In one embodiment, the inspection device 1 has a same given point of departure and arrival: X_{B}, but does not pass back again through X_{B} between two distinct components of the list.

In step 202, a minimization of the movements along the axis Z of the arm between two consecutive tasks while also avoiding any interference with the train 2, is brought about.

Steps 201, 202 are, for example, operationally implemented in the inspection device 1, by making use of the microprocessor 12 and a sequence optimization algorithm stored in the memory storage 14. The best options for the inspection route and the elementary movements of the inspection device 1 (both of the carriage 7 as also of the arm 9) are thus calculated.

Step 202 is operationally implemented according to a static envelope of the train (which varies according to the 3-dimensional shapes and forms of the components of the train 2) which represents the border, in terms of height (i.e., along the axis Z) beyond which the upper limit of the camera at the end of the arm 9 is not able to go, for each geographical position (x, y) given in the plane defined by the axes X and Y. This envelope therefore delimits the surface area of at least the underframe of the train 2.

This static envelope of the train is defined for example for each type of railway vehicle, in a respective file of the 3-dimensional matrix, denoted as B₁, stored in the memory storage 14. The envelope (or ceiling) is provided for by the designer of the train by making use of the CAD tool, or outputted by the robot by means of an automated scanner mode and dedicated sensors.

Thus, after each identification of railway vehicle (performed automatically by the inspection device 1, in particular by means of image processing or indeed indicated in manual mode to the device 1 by the operator from the monitoring-management station), the processing block 10 of the inspection device 1 selects the static envelope file corresponding to the railway vehicle 2 identified. In the event that the identification of the railway vehicle is not possible, or if the static envelope file that is appropriate is missing or unusable, a default envelope corresponding to a safety static rail loading gauge (clearance loading gauge) specified by the operator (UIC International Union of Railways standard for example) is used.

These provisions contribute to reducing the time and the energy consumption required to effectively complete the inspection sequence for railway vehicles.

For the purposes of illustration and comparison, the successive steps between the end of any task (denoted as “task N−1”) and that of the subsequent task (denoted as “task N”), the ordered scheduling of the tasks having been obtained following conclusion of step 201, are described herebelow, first of all according to one embodiment not involving the use of the envelope matrix, in steps 301 to 309, and then according to one other embodiment involving the use of the envelope matrix, in steps 401 to 408.

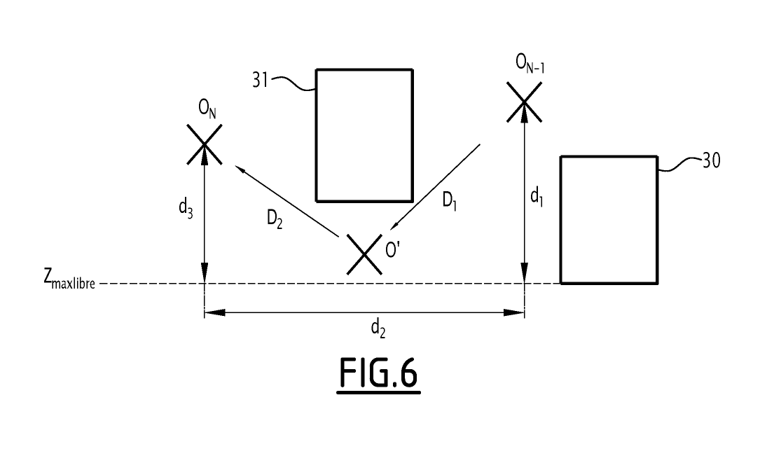

FIG. 6 represents in the plane of the axes X and Z the locational position O_{N-1} of coordinates (x_{N-1}, y_{N-1}, z_{N-1}) corresponding to the task N−1, the locational position O_{N} of coordinates (x_{N}, y_{N}, z_{N}) corresponding to the task N, and the components 30 and 31 of the train appearing in the vicinity. The task N−1 is, for example, the taking of a photo of the component 31, and the task N is, for example, the taking of a photo of the component (not shown) situated further along the axis X.
Step 301: end of the task N−1 at the locational position O_{N-1}.
Step 302: lowering the arm 9 to the height z=Z_{max-free} (height of the lowest element of the train 2), as represented by the arrow d₁ in FIG. 6.
Step 303: centering the arm 9 between the two rails 5 and 6 (y=0).
Step 304: moving the carriage 7 along the axis X up to the locational position x_{N} along X corresponding to the task N, as represented by the arrow d₂ in FIG. 6.
Step 305: positioning the arm laterally, i.e., along the axis Y, up to the locational position y_{N} along Y corresponding to the task N.
Step 306: positioning the arm vertically, i.e., along the axis Z, up to the locational position z_{N} along Z corresponding to the task N, as represented by the arrow d₃ in FIG. 6.
Step 307: orienting the head of the camera 11.2.
Step 308: executing the task N (image capture, measurement, etc.).
Step 309: end of the task N; N=N+1; returning to step 301 if the sequence of tasks has not been concluded.

Thus, in step 302, the arm is systematically lowered below the height of the lowest element of the train 2.
Step 401: end of the task N−1
Step 402: determining whether there is an intersection along the axis Z with the train 2 in order to go directly from the locational position O_{N-1}, of coordinates (x_{N-1}, y_{N-1}, z_{N-1}) corresponding to the task N−1, to the locational position O_{N}, of coordinates (x_{N}, y_{N}, z_{N}) corresponding to the task N, based on the segment between (x_{N-1}, y_{N-1}, z_{N-1}) and (x_{N}, y_{N}, z_{N}) and the envelope file B₁ of the envelope corresponding to the train 2 inspected. If yes, going to step 403; if no, going to step 405 directly.
Step 403: determining one intermediate position O′ (or more) such that it is possible to go from O_{N-1} to O′, then from O′ to O_{N}, while minimizing the total distance travelled (in 3 dimensions) by going along the axis X from x_{N-1} to x_{N}, on the basis of the envelope file B₁ corresponding to the train 2 inspected.
Step 404: moving the carriage 7 (along X) and the arm 9 (along Z) up to the intermediate position O′, in accordance with the movement indicated by the arrow D₁ in FIG. 6.
Step 405: moving the carriage 7 and the arm 9 from the current position up to O_{N} along the axis indicated by the arrow D₂ in FIG. 6.
Step 406: orienting the head of the camera 11.2.
Step 407: executing the task N (image capture, measurement, etc.).
Step 408: end of the task N; N=N+1; returning to step 301 if the sequence of tasks has not been concluded.
   The sum of the distances represented by the arrows d₁, d₂ and d₃ amounts to d₁+d₂+d₃=200+2500+180=2880 millimeters (mm), and is traveled in the case considered in 14 seconds (s). The sum of the distances represented by the movements along the arrows D₁ and D₂ amounts to D₁+D₂=1266+1262=2528 mm, and is traveled in the case considered in 12 s.

1. A railway vehicle underframe inspection method for inspecting the underframe of a railway vehicle on a railway track by an inspection device that includes a processing block and a motor system, the processing block commanding and controlling the motor system, and the motor system moving the inspection device until it is positioned at least at one destination point, wherein a list of coordinates of points of interest of the underframe, expressed in a reference frame having as origin a reference point, is saved and stored in the processing block, the method comprising:
moving, by the motor system, the inspection device up to a predetermined point whose position relative to the reference point is known;
recording and saving, by the processing block, the location of the reference point as a function of the position up to which the inspection device has been moved; and
determining, by the processing block, at least one command to be sent to the motor system to position the inspection device at least at one point of interest from the list based on at least the coordinates of the point of interest expressed in the list, and the recorded and saved location of the reference point.

2. The railway vehicle underframe inspection method of claim 1, further comprising sending, by the processing block, the at least one command to the motor system, in response to which the inspection device moves as a result of the action of the motor system up to the point of interest and captures an image thereof or performs a measurement thereat.

3. The railway vehicle underframe inspection of claim 1, wherein the predetermined point is an axle of the railway vehicle, the location of the reference point on an axis X extending parallel to the track corresponding to the axle on the axis X, the location of the reference point on an axis Y, situated in the plane of the track and perpendicular to the rails of the track, being determined as a function of the location of at least one of the two rails on the axis Y, and the location of the reference point on an axis Z, perpendicular to the axes X and Y, being determined as a function of the location of at least one of the two rails on the axis Z.

4. The railway vehicle underframe inspection method of claim 1, further comprising:
calculating an envelope of a surface of the underframe of the railway vehicle; and
determining motion of the inspection device to be brought about between two successive points of interest in the list by implementing a minimization algorithm for minimizing the motion brought about in 1 dimension, 2 dimensions or 3 dimensions, the minimization being performed based on the points of the list and the envelope calculated.

5. A non-transitory computer readable medium storing instructions which, when executed by a processor of a computer, cause the computer to perform the method of claim 1.

6. A railway vehicle underframe inspection device for inspecting the underframe of a railway vehicle on a railway track comprising:
a motor system moving the inspection device until it is positioned at least at one destination point; and
a processing block (i) commanding and controlling said motor system, (ii) saving and storing a list of coordinates of points of interest of the underframe expressed in a frame of reference having as origin a reference point, (iii) following motion of the inspection device up to a predetermined point whose position relative to the reference point is known, (iv) recording and saving a location of the reference point as a function of the position up to which the inspection device has been moved, and (v) determining at least one command to be sent to said motor system in order to position the inspection device at least at one point of interest from the list, based on at least the coordinates of the point of interest, and the recorded and saved location of the reference point.

7. The railway vehicle underframe inspection device of claim 6, wherein said processing block sends the at least one command to said motor system, and then, in response to the at least one command, the inspection device moves, as a result of the action of said motor system, up to the point of interest and captures an image thereof or performs a measurement thereat.

8. The railway vehicle underframe inspection device of claim 6, wherein the predetermined point is an axle of the railway vehicle, the location of the reference point on an axis X extending parallel to the track corresponding to the axle on the axis X, the location of the reference point on an axis Y, situated in the plane of the track and perpendicular to the rails of the track, being determined as a function of the location of at least one of the two rails on the axis Y, and the location of the reference point on an axis Z, perpendicular to the axes X and Y, being determined as a function of the location of at least one of the two rails on the axis Z.

9. The railway vehicle underframe inspection device of claim 6, wherein said processing block determines motion of the inspection device to be brought about between two successive points of interest of the list by implementing a minimization algorithm for minimizing the motion brought about in 1 dimension, 2 dimensions or 3 dimensions, the minimization being performed based on the points of the list and an envelope of a surface of the underframe of the railway vehicle.
